(19) United States
(12) Patent Application Publication
(10) Pub. No.: US 2010/0092149 A1
(43) Pub. Date: Apr. 15, 2010

(54) AV COMPLEX EDITING APPARATUS, AV PROCESSOR, AND PROGRAM

(75) Inventors: Kazuo Ishikawa, Sayama-shi (JP); Yoshitaka Nojima, Tokorozawa-shi (JP); Tatsuya Shiraishi, Tokyo (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/530,358

(22) PCT Filed: Mar. 9, 2007
(86) PCT No.: PCT/JP2007/000197

§ 371 Date: Sep. 8, 2009

(51) Int. Cl. G11B 27/022

(52) U.S. Cl. 386/52; 345/173; 386/E05.003

(57) ABSTRACT

An AV complex editing apparatus includes an effect category selecting unit (E1) which selects any effect category among a plurality of effect categories, and an effect mode selecting unit (E4) which selects a signal to be an object of effect processing. The specification of an effect operation screen 210 is changed in accordance with a selected result by the effect category selecting unit (E1), while the specification of the effect operation screen 210 is not changed in accordance with a selected result by the effect mode selecting unit (E4).

### TECHNICAL FIELD

The present invention relates to an audio and visual (AV) complex editing apparatus, an AV processor, and a program which perform editing processing, such as effect processing, to AV signals which are audio signals or video signals.

### BACKGROUND ART

In recent years, audio effectors which add effects, such as a delay and an echo, to audio signals have been known (for example, Patent Document 1). Similarly, video effectors which add effects, such as a spotlight and a lens, to video signals have been also known.

Audio equipment, such as audio effectors, is often applied to DJ equipment (equipment used by disk jockeys [DJs] for acoustic performances) used in clubs or other venues. Similarly, video equipment, such as video effectors, is often applied to VJ equipment (equipment used by visual or video jockeys [VJs] for video performances) used to display diversified video images on monitors in clubs or other venues. Thus, although such DJ equipment and VJ equipment have many common features in terms of places to be used and needs, since special operations are required for each, it is not common practice to operate the both by the same person. In addition, a booth for a DJ or VJ to operate in a club or the like is so small that it is difficult to install both of the DJ equipment and the VJ equipment in the booth. For such a reason, it has been a common sense that the DJ equipment and the VJ equipment are operated by different persons.

### [Patent Document 1] JP-A-9-160581

### DISCLOSURE OF THE INVENTION

### Problems to be Solved

However, when different persons operate the DJ equipment and the VJ equipment, a gap may occur between music and video images to be output. Generally, a VJ switches video images or applies an effect to video images in accordance with the music operated by a DJ. However, even if the DJ and the VJ make arrangements carefully in advance, the performance by the DJ often changes with the enthusiastic response of the audience and the atmosphere in the venue. Therefore, there is a problem that the VJ cannot suitably change video images in synchronization with a sudden change of beats or sound tones.

For this reason, in order to get music and video images synchronized, it is most preferred to operate the DJ equipment and the VJ equipment by the same person, which is practically difficult because of operability or space requirements as described above.

In order to solve the problem of space requirements, it is preferred to use sound/video equipment capable of operating both music and video images by one unit. However, since DJs and VJs have different specialized fields, respectively, the form or operation methods of operators that are easy for them to use differ. Therefore, if usability for each is taken into consideration, it is necessary to arrange a large number of operators to enable various operations. Thus, there has been a problem that such equipment will be enlarged after all.

In view of the above-described problems, an object of the present invention is to provide an AV complex editing apparatus, an AV processor, and a program which can perform editing operation to audio signals and video signals with good operability in a space-saving manner.

### Means to Solve the Problems

An AV complex editing apparatus according to the present invention includes: an effect category selecting unit which selects any effect category among a plurality of effect categories including a BPM effect category which is a function to perform effect processing mainly in accordance with BPM to an AV signal which is an audio signal or a video signal, and a touch effect category which is a function to perform the effect processing mainly in accordance with an operation result of a video image to the AV signal; an effect mode selecting unit which selects any effect mode among three effect modes: an audio mode which performs the effect processing only to the audio signal, a video mode which performs the effect processing only to the video signal, and an audio/video mode which performs the effect processing to the audio signal and the video signal; an operating unit which performs various editing operations including an effect operation for performing the effect processing by using a touch panel with a display function; a display control unit which performs display control of the touch panel with the display function; and an effect processing unit which performs the effect processing to at least any one of the audio signal and the video signal, based on selected results by the effect category selecting unit and the effect mode selecting unit, and an operation result by the operating unit. The display control unit changes a specification of an effect operation screen for performing the effect operation in accordance with the selected result by the effect category selecting unit, and does not change the specification of the effect operation screen in accordance with the selected result by the effect mode selecting unit.

Since this configuration provides the function of an effect category, namely, any of the BPM effect category and the touch effect category, in a single apparatus, space efficiency is higher than a case where apparatuses for providing individual functions are installed one by one. Since the effect processing to an audio signal and a video signal can be performed in a single apparatus, the space efficiency is further better than a case where apparatuses for performing the effect processing of individual signals are installed one by one. Since each effect category can be operated by using the touch panel with the display function, only one touch panel with the display function needs to be installed as an operating unit for performing each effect category. The apparatus can be downsized even with lower cost than a case where operating units for operating individual effect categories are provided. Since the specification of the effect operation screen is changed in accordance with the effect category which a user selects, operability is not compromised even if a priority is given to downsizing.

Since the specification of the effect operation screen is not changed in accordance with the effect mode, a common operation method can be adopted, which makes it easier for users to learn the operation method. By the common operation method, DJs and VJs can operate music and video images irrespective of their specialties, whereby versatility can be enhanced.

In the AV complex editing apparatus described above, it is preferable that the selected result by the effect mode selecting unit be displayed on the effect operation screen.

With this configuration, while the specification of the effect operation screen is not changed in accordance with the selected result by the effect mode selecting unit, since the selected result by the effect mode selecting unit is displayed, the user can distinguish which signal is an object to be processed.

In the AV complex editing apparatus described above, it is preferable that the effect category selecting unit select any effect category among a plurality of effect categories including a text effect category which is a function to perform the effect processing mainly by using an input result of a text to the AV signal, in addition to the BPM effect category and the touch effect category.

With this configuration, text effects, which have attracted attention as a function of VJ equipment or the like, can be provided. Since the touch panel with the display function is used as the operating unit, addition of the text effect category requires no special configuration to be added accordingly. Therefore, since text effects can be provided at a low cost, and the specification of the effect operation screen is also changed so that such text effects can be provided easily, operability is also good.

In the AV complex editing apparatus described above, it is preferable that an effect type option group for selecting an effect type and a video operating area for displaying the video image and performing a part of the effect operation be displayed on the effect operation screen; and the display control unit change, in accordance with the selected result by the effect category selecting unit, at least any one of the effect type included in the effect type option group and a size of the video operating area.

With this configuration, since the effect type is changed in consideration of usage that may vary depending on each effect category, convenience can be improved. When the touch effect category is selected, it can be assumed that the video operating area will be frequently accessed. In response, operability can be improved by enlarging the size of the video operating area when the touch effect category is selected.

It is preferable that the AV complex editing apparatus described above further include a display area selecting unit which selects whether or not an output video displaying area for displaying an output video image is provided in the effect operation screen, and that the display control unit make the size of the video operating area small, and do not change a size of each option in the effect type option group in a case where the display area selecting unit selects that the output video displaying area is provided, as compared with a case where it is selected that the output video displaying area is not provided.

With this configuration, in accordance with the preference and the usage of the user, whether or not the output video displaying area is provided in the effect operation screen can be selected. Even when providing the output video displaying area in the effect operation screen, since the size of each option in the effect type option group is not changed, compromising effects on operability can be reduced.

In the AV complex editing apparatus described above, it is preferable that a category option group which displays each option of the effect category selecting unit and a mode option group which displays each option of the effect mode selecting unit be displayed on the effect operation screen.

With this configuration, since the effect category and the effect mode can be selected with the effect operation screen, a physical operator for realizing each selecting unit is not needed.

In the AV complex editing apparatus described above, it is preferable that the operating unit perform a mixing operation for performing mixing processing as the editing operation, and the touch panel with the display function display a mixing operation screen for performing the mixing operation. In addition, it is preferable that the AV complex editing apparatus further include: a mixing category selecting unit which selects any mixing category among a plurality of mixing categories including a crossfader category which performs the mixing processing to the AV signal by using a crossfader, and a transition pad category which performs the mixing processing to the AV signal by using a transition pad; and a mixing processing unit which performs the mixing processing to at least any one of the audio signal and the video signal based on operation results by the mixing category selecting unit and the operation result by the operating unit, and that the display control unit change a specification of the mixing operation screen in accordance with the selected result by the mixing category selecting unit.

This configuration provides not only the effect processing but also the mixing processing. Since the function of the mixing category, namely, any of the crossfader category and the transition pad category, can be provided in a single apparatus, space efficiency is higher than a case where apparatuses for providing individual functions are installed one by one. Since each mixing category can be operated by using a part of the touch panel with the display function, no special configuration is required to be added to operate each mixing category, whereby upsizing of the apparatus can be prevented. Since the specification of the mixing operation screen is changed in accordance with the mixing category which the user selects, operability is not compromised even if a priority is given to downsizing.

Note that, the “transition pad” includes pads for assigning each channel of the AV signal which are prepared in the number of the channels, and can make the channel to be an object of the mixing processing transit in accordance with the assignment by the pad.

It is preferable that the AV complex editing apparatus described above further include a mixing mode selecting unit which selects the video signal only or both the audio signal and the video signal, as an object to be processed by the mixing processing unit, independent from the effect mode selecting unit.

With this configuration, the object to be processed in the effect processing and the object to be processed in the mixing processing can be set individually.

Note that, it is preferable in this case to provide an operator separately for making only the audio signal to be the object to be processed in the mixing processing.

An AV processor according to the present invention includes: each of the units included in the AV complex editing apparatus described above; an input unit to which the AV signal is input; and an output unit which outputs an output AV signal obtained by effect-processing the input AV signal by the effect processing unit.

With this configuration, an AV processor which can perform an editing operation including an effect operation to an input AV signal with good operability in a space-saving manner can be provided.

A program according to the present invention causes a computer to function as each of the units included in the AV complex editing apparatus described above.

By executing this program, an AV complex editing apparatus which can perform an editing operation including an effect operation to an audio signal and a video signal with good operability in a space-saving manner can be provided.

### BRIEF DESCRIPTION OF THE DRAWINGS

FIG. 1A is a system schematic diagram of an AV processing system.

FIG. 1B is a simple schematic diagram of an AV processor, according to an embodiment of the present invention.

FIG. 2 is a view showing a user interface provided to the AV processor.

FIG. 3 is a block diagram of the AV processor.

FIG. 4A is an explanatory view of an effect category.

FIG. 4B is an explanatory view of a mixing category.

FIG. 5 is a view showing a display example of a BPM effect category (performance mode).

FIG. 6 is a view showing a display example of a BPM effect category (all-in-one mode).

FIG. 7 is a view showing a display example of a touch effect category (performance mode).

FIG. 8 is a view showing a display example of a touch effect category (all-in-one mode).

FIG. 9 is a view showing a display example of a text effect category (performance mode).

FIG. 10 is a view showing a display example of a text effect category (all-in-one mode).

FIG. 11 is a view showing a display example of a crossfader category.

FIG. 12 is a view showing a display example of a transition pad category.

### REFERENCE NUMERALS

10 CD player
20 DVD player
30 AV processor
31 user interface
32 microcomputer
33 signal processor
51 BPM auto button
52 hold button
53 text edit button
54 text bank
62 synchronization switching button
100 physical operating unit
200 touch panel operating unit
210 effect operation screen
220 mixing operation screen
E1 effect category selecting area
E2 channel displaying area
E3 effect type selecting area
E4 effect mode selecting area
E5 video operating area
E6 beat selecting area
E7 video parameter displaying area
E8 effect parameter displaying area
E9 output video displaying area
E11 CH monitor area
E12 mixing type selecting area
E13 beat selecting area
SY AV processing system
TP touch panel

### BEST MODES FOR CARRYING OUT THE INVENTION

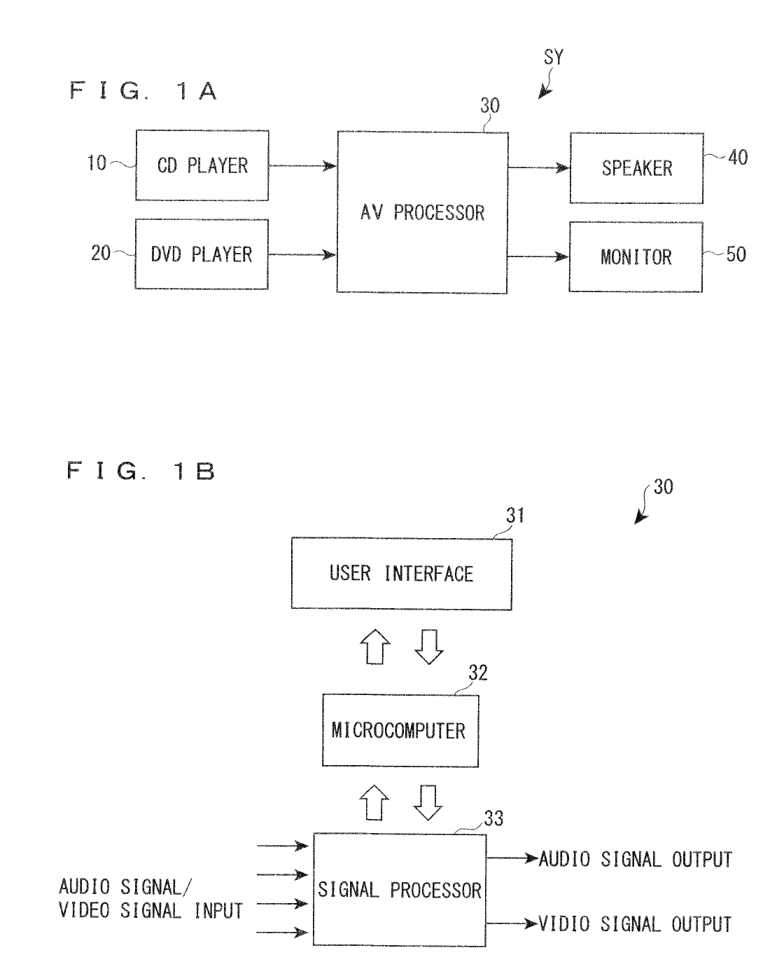

An AV complex editing apparatus, an AV processor, and a program according to an embodiment of the present invention will now be explained in detail with reference to the accompanying drawings. FIG. 1A is a system schematic diagram of an AV processing system SY to which an AV processor 30 according to the present invention is applied. The AV processing system SY includes: one or more CD players 10 (only one CD player 10 is shown in the diagram); one or more DVD players 20 (only one DVD player 20 is shown in the diagram); the AV processor 30; a speaker 40; and a monitor 50. The CD players 10 generate one or more audio signals to be input to the AV processor 30. The DVD players 20 generate one or more video signals to be input to the AV processor 30. The AV processor 30 edits the one or more audio signals and/or the one or more video signals (hereinafter, an audio signal and/or a video signal are referred to as an “AV signal”) input from the one or more CD players 10 and/or the one or more DVD players 20, and generates an output AV signal. The speaker 40 audio-outputs the audio signal output from the AV processor 30. The monitor 50 displays the video signal(s) output from the AV processor 30.

The AV processor 30 according to this embodiment performs various editing processing, such as effect processing which adds an effect to the input AV signal. Examples of the AV processor 30 include DVJ equipment used in clubs or other venues. The DVJ equipment processes audio signals and/or video signals just like with a musical instrument, by applying an effect to both sound and video images, for example. The DVJ equipment is equipment combined with DJ equipment used by disk jockeys (DJs) for acoustic performances and VJ equipment used by visual or video jockeys (VJs) for video performances.

Here, VJs and DJs will be defined. VJs mix (synthesize or join) video images improvisatorially in harmony with music. They use video images for their performances, while DJs mix music improvisatorially. VJs switch and output video images on a screen or the like mainly at an event or a club party, and select suitable video images on that spot at a good timing in harmony with the music played in the venue or any program in progress.

On the other hand, DJs select musical compositions depending on the atmosphere of the venue, and play the musical compositions intermittently. They use, for example, turntables for their performances, with which they can change the pitch (speed) of musical compositions. Performances other than selecting musical compositions, they commonly perform DJ mixes and scratches, for example. During mixes, they connect the music being played now and the music to be played next smoothly without any break of sound to keep the tension of the floor.

VJs and DJs generally perform separately under the present circumstances. Most of them specialize in performances of either music or video images. Since each has a specialized field, it is difficult for them to mix objects beyond their specialized fields. With only either music or video images being targeted, VJs and DJs are very busy in applying effects while continuing performances improvisatorially with various manual operations. Therefore, they cannot afford to handle both music and video images.

However, both the performances require performers to change and output musical compositions and video images depending on the atmosphere in the venue or the performers' own feelings. Since sound and video images are provided in line with each other, it is desirable for one person to perform both the performances. Even VJs who are good at processing video images can handle music easily in addition to video images if the music changes as the video changes. Conversely, DJs who are dedicated to acoustic performances can also handle both sound and video images more naturally if the video images change as the sound changes.

The AV processor 30 according to this embodiment makes it possible for one person to handle music and video images simultaneously, which has been practically impossible. A simple and comfortable operation is provided to a person who tries to handle both music and video images.

As a device for generating AV signals to be input to the AV processor 30, other devices (various types of audio equipment, video equipment, and personal computers, for example) can be used, not limited to the CD player 10 or the DVD player 20. The functions of the CD player 10 or the DVD player 20 can be made to build in the AV processor 30. Further, the video signals can be animation or still images. When a plurality of audio signals are input to the AV processor 30, in order to eliminate a sense of discomfort in mixing the audio signals, it is preferred that the function to coincide BPM of the audio signals be equipped on either the CD player 10 side or the AV processor 30 side.

FIG. 1B is a simple schematic diagram of the AV processor 30. The AV processor 30 has a user interface 31, a microcomputer 32, and a signal processor 33, as main components thereof.

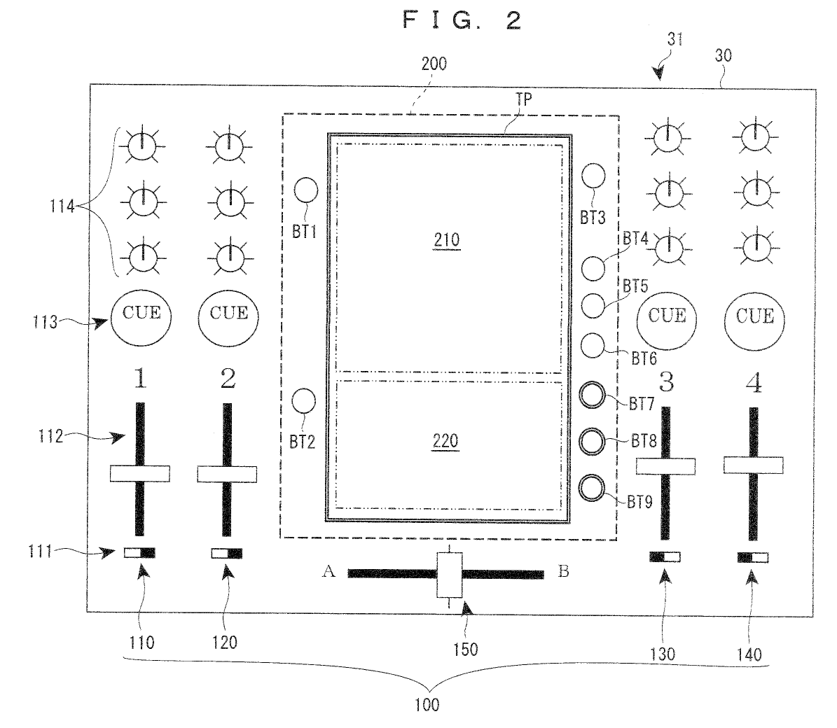

The user interface 31 includes a touch panel TP with a display function, and various operators such as faders 112 and knobs 114 which are physically mounted (see FIG. 2). The touch panel TP with the display function performs most of the editing operation in this embodiment, and includes a display having a display element, such as a thin-film transistor (TFT), and a touch panel superimposed on the display. In this manner, by mainly applying the touch panel TP with the display function (hereinafter referred to as simply “touch panel TP”) as the user interface 31, a user can operate a touch panel displayed on the display so that the user can perform simple and intuitive operations.

The microcomputer 32 performs position detection or motion detection of operational positions depending on voltage changes based on the operation (touch) of the touch panel TP when the touch panel TP is operated. Further, the microcomputer 32 generates a control signal for commanding the editing processing of the input AV signals based on the detection result, and outputs the control signal to the signal processor 33 (an audio/video control device).

The signal processor 33 performs effect processing or mixing processing of each of the input AV signals based on the control signal input from the microcomputer 32, generates an audio signal to be output and/or a video signal to be output (hereinafter referred to as “output AV signals”) based on the processing result, and outputs each of the signals from corresponding output interfaces.

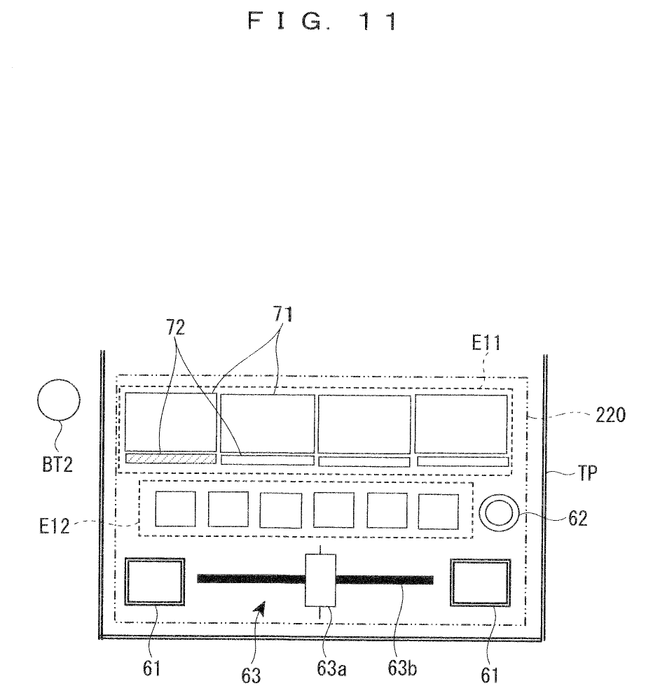

The signal processor 33 outputs video images based on the input video signals to the microcomputer 32. The microcomputer 32 performs display control to display the video images on predetermined areas on the touch panel TP, for example (a CH monitor area E11, see FIG. 11 and other drawings). In addition, the microcomputer 32 performs general control over the AV processor 30, such as an information management based on an operation by the operator, input and output of signals to and from an external device.

The signal processor 33 preferably performs synchronous processing for synchronizing a plurality of signals to be output. Accordingly, a sense of discomfort, such as a delay occurred in the output signals, can be eliminated. Further, it is also possible to perform double processing in which the output AV signals are returned to the signal processor 33 again, and editing processing is further performed to the post-editing AV signals.

Next, with reference to the plan view of FIG. 2, the user interface 31 equipped to the AV processor 30 will be explained. As shown in the view, the user interface 31 of the AV processor 30 includes a physical operating unit 100 where various operators physically mounted are arranged, and a touch panel operating unit 200 for performing operations mainly on the touch panel TP.

The physical operating unit 100 includes a CH1 operator group 110 to a CH4 operator group 140 for performing the editing operation of each AV signal input to CH1 to CH4, and a crossfader 150 physically mounted. Each of the operator groups 110 to 140 includes operators, such as CF assign switches 111, the faders 112, CUE buttons 113, and the level adjustment knobs (equalizers) 114 similar to a common audio mixer. The crossfader 150 adjusts the output level of each AV signal assigned to “A” or “B” by the CF assign switches 111.

The touch panel operating unit 200 includes the touch panel TP, and operation buttons BT1 to BT9 physically mounted for performing auxiliary operations of the touch panel TP. The lengthwise direction of the panel coincides with the longitudinal direction of the touch panel TP, and one panel is divided into two, upper and lower areas. The upper area of the touch panel TP is used to mainly perform effect operations, and is referred hereinafter as an “effect operation screen 210”. The lower area of the touch panel TP is used to mainly perform mixing operations, and is referred hereinafter as a “mixing operation screen 220”.

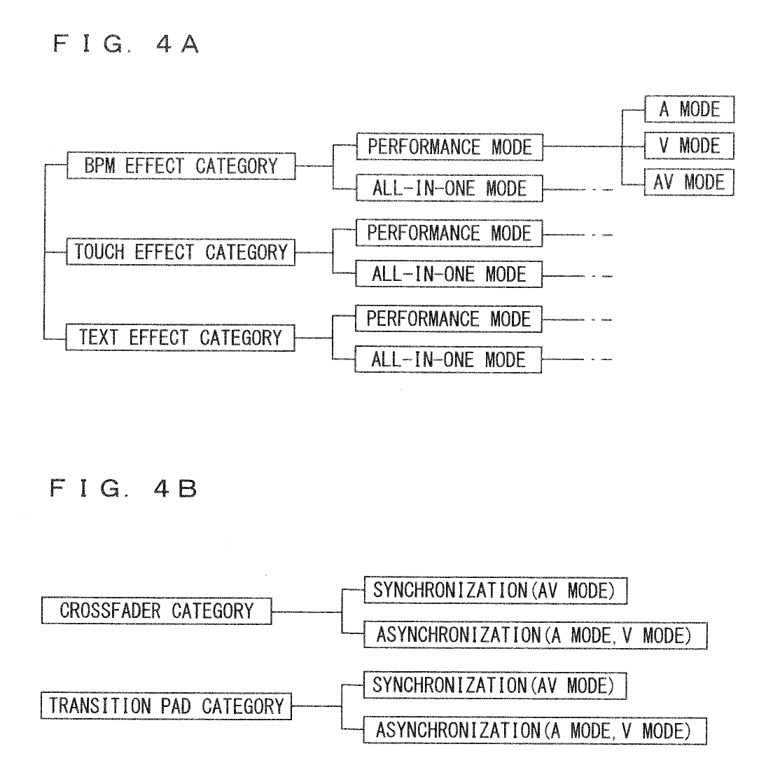

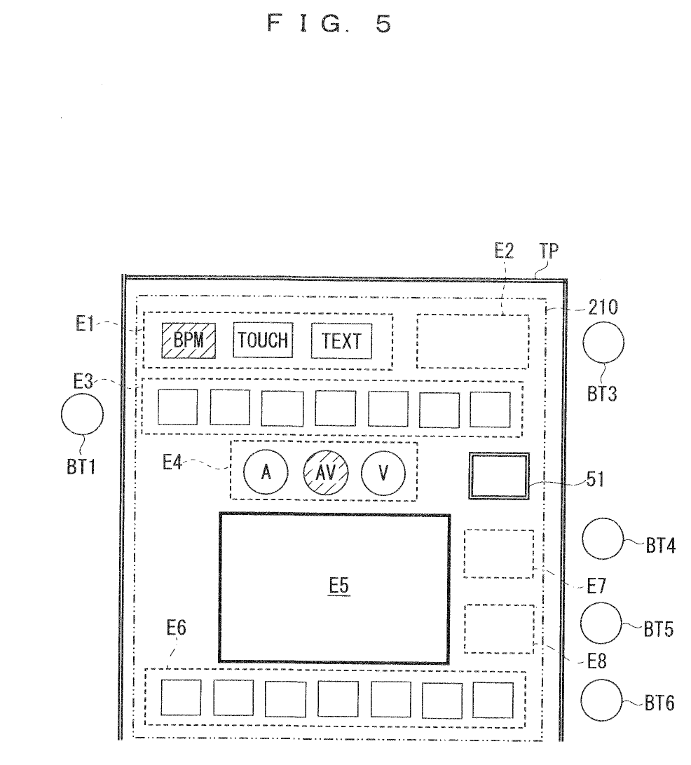

The operation buttons BT1 to BT8 are briefly explained here, and will be described later with reference to a display example of each of the operation screens 210 and 220 (see FIG. 5 to FIG. 12). The operation button BT1 is an effect mode switching button for switching modes (see FIG. 4A) of the effect processing. The operation button BT2 is a mixing category switching button for switching categories of the mixing processing (see FIG. 4B). The operation button BT3 is an effect channel switching button for switching channels to be an object of the effect processing. The operation button BT4 is a video parameter selecting button for selecting a video parameter of the effect processing. The operation button BT5 is an effect parameter switching button for switching effect parameters (BPM, for example) of the effect processing. The operation button BT6 is a beat button for performing BPM effect performances. In addition, the operation buttons BT7 to BT8 are mounted also in commonly used audio mixers, and are a CUE button BT7, a TAP button BT8, and an ON/OFF switching button BT9 (a button for switching whether or not the processing result of the editing processing is made to reflect on output AV signals).

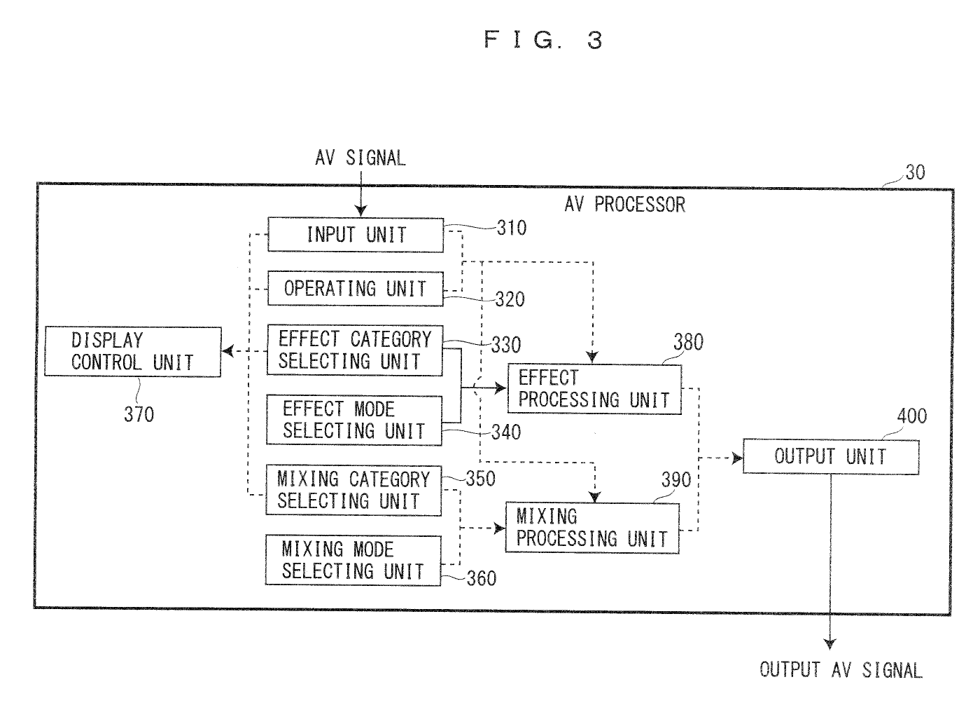

Next, with reference to the block diagram of FIG. 3, a control configuration of the AV processor 30 will be explained. As shown in the diagram, the AV processor 30 includes an input unit 310, an operating unit 320, an effect category selecting unit 330, an effect mode selecting unit 340, a mixing category selecting unit 350, a mixing mode selecting unit 360, a display control unit 370, an effect processing unit 380, a mixing processing unit 390, and an output unit 400.

The input unit 310 is a unit to which AV signals are input and its principal part is constituted by a signal input interface (an analog or a digital signal input terminal), which is not shown. The operating unit 320 performs various editing operations for performing the effect processing or the mixing processing, and its principal part is constituted by the touch panel TP.

The effect category selecting unit 330 selects any effect category among a plurality of effect categories, and its principal part is constituted by the touch panel TP (an effect category selecting area E1 in the effect operation screen 210, see FIG. 5 and other drawings). Specifically, any effect category can be selected among three effect categories: a BPM effect category which is a function to perform the effect processing mainly in accordance with BPM; a touch effect category which is a function to perform the effect processing mainly in accordance with an operation result of video images; and a text effect category which is a function to perform the effect processing by mainly using an input result of a text.

The effect mode selecting unit 340 selects signals to be objects of the effect processing, and its principal part is constituted by the touch panel TP (the effect category selecting area E4 in the effect operation screen 210, see FIG. 5 and other drawings). Specifically, any effect mode can be selected among three effect modes: an audio mode which performs the effect processing only to audio signals (hereinafter, referred to as an “A mode”); a video mode which performs the effect processing only to and video signals (hereinafter, referred to as a “V mode”); and an audio/video mode which performs the effect processing only to audio signals and video (hereinafter, referred to as an “AV mode”). Selecting the “AV mode” makes it possible to change music and video images (pictures) at the same timing by one operation. In other words, a change start at the completely same timing, which is unattainable by a pair of a DJ and VJ, can be realized.

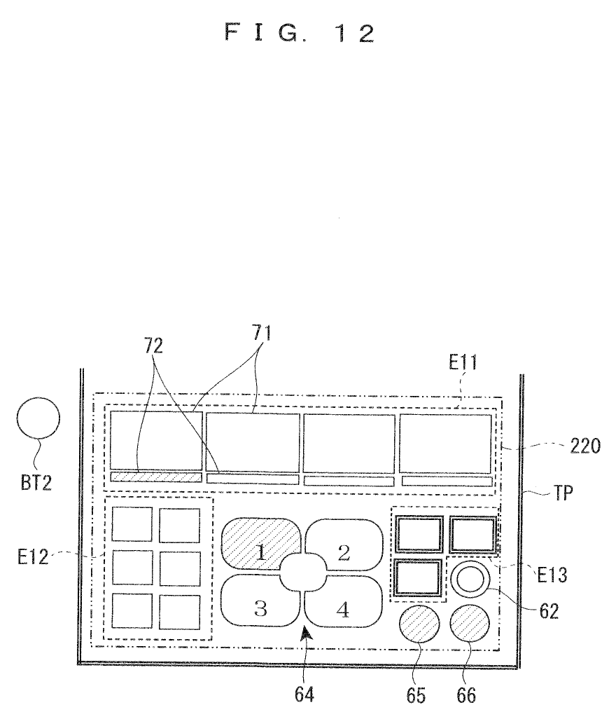

The mixing category selecting unit 350 selects any mixing category among a plurality of mixing categories, and its principal part is constituted by the mixing category switching button BT2 (see FIG. 2 and other drawings). Specifically, any of a crossfader category which performs the mixing processing by using a crossfader 63 displayed on a graphical user interface (GUI) (see FIG. 11), and a transition pad category which performs the mixing processing by using transition pads 64 (see FIG. 12) can be selected.

The mixing mode selecting unit 360 selects signals to be objects of the mixing processing, and its principal part is constituted by the touch panel TP (a synchronization switching button 62 in the mixing operation screen 220, see FIG. 11 and other drawings). Specifically, the AV mode of the mixing processing can be selected by setting the synchronization switching button 62 as “synchronization”. The V mode of the mixing processing can be selected by setting the synchronization switching button 62 as “asynchronization”. Further, when making only audio signals objects to be processed in the mixing processing (when selecting the A mode), the crossfader 150 physically mounted (see FIG. 2) is used. In this manner, since the mixing mode selecting unit 360 can select signals to be processed independent from the effect mode selecting unit 340, objects to be processed can be individually selected for the effect processing and the mixing processing, and a wider range of musical expressions or video expressions can be provided.

The display control unit 370 performs display control of the touch panel TP, and its principal part is constituted by the microcomputer 32 (see FIG. 1B). The display control unit 370 changes the specification of the effect operation screen 210 in accordance with a selected result by the effect category selecting unit 330, and does not change the specification of the effect operation screen 210 in accordance with a selected result by the effect mode selecting unit 340. In other words, while improvement in operability is aimed by changing the specification of the effect operation screen 210 in accordance with the effect categories with different operation forms, the specification of the effect operation screen 210 is not changed in accordance with the effect modes with different signals to be processed. This makes an operation method to be common to enhance convenience and flexibility. Further, the display control unit 370 changes the specification of the mixing operation screen 220 in accordance with a selected result by the mixing category selecting unit 350 to further improve operability of the mixing operation.

The effect processing unit 380 performs the effect processing to the input AV signals based on the selected results by the effect category selecting unit 330 and the effect mode selecting unit 340 and the operation result by the operating unit 320, and its principal part is constituted by the microcomputer 32 and the signal processor 33 (see FIG. 1B).

The mixing processing unit 390 performs the mixing processing to the input AV signal based on the selected results by the mixing category selecting unit 350 and the mixing mode selecting unit 360, and the operation result by the operating unit 320, and its principal part is constituted by the microcomputer 32 and the signal processor 33 (see FIG. 1B).

The output unit 400 outputs output AV signals after the processing by the effect processing unit 380 and/or the mixing processing unit 390, and its principal part is constituted by a signal output interface (an analog or digital signal output terminal), which is not shown.

Next, each functional configuration of the effect category and the mixing category will be explained with reference to FIG. 4. As shown in FIG. 4A, any effect category can be selected among the BPM effect category, the touch effect category, and the text effect category. Each effect category can be provided by selecting any effect among a plurality of effect types (an effect type selecting area E3, see FIG. 5 and other drawings). Note that, the content of the effect types may completely differ in accordance with the effect category, and may be the same in part.

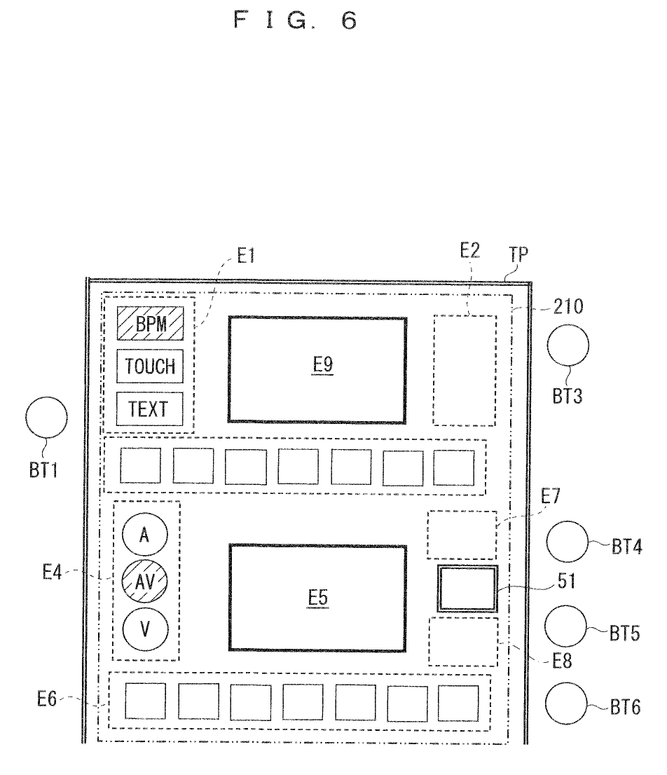

Each effect category can select any of a performance mode (see FIG. 5 and other drawings) in which an output video display area E9 (see FIG. 6 and other drawings) is not provided in the effect operation screen 210, and an all-in-one mode in which the output video display area E9 is provided in the effect operation screen 210 (display area selecting unit). Literally, the performance mode is a mode which is selected to fully use the effect operation screen 210 for performances, aiming at improvement in operability. The all-in-one mode is a mode which is selected to check output video images without requiring an external monitor or the like.

In each effect category and each mode, the effect modes (any of the A mode, the V mode, and the AV mode) can be selected as described above. Thus, a wide range of the effect processing with the different effect modes and effect types can be performed with the effect operation screen 210, and an operation method thereof can also be changed in accordance with the effect category.

FIG. 4B is a view showing a functional configuration of the mixing category. As shown in the view, any of the crossfader category and the transition pad category can be selected as a mixing category. Each mixing category can be provided by selecting any mixing type among a plurality of mixing types (a mixing type selecting area E12, see FIG. 11 and other drawings). Note that, the content of the mixing types may completely differ in accordance with the mixing category, and may be the same in part.

In each mixing category, “synchronization” for operating audio signals and video signals simultaneously (in synchronization with each other), and “asynchronization” for operating audio signals and video signals individually can be selected. Therefore, as a mixing mode, the AV mode can be selected by selecting the synchronization, and the A mode or the V mode can be selected by selecting the asynchronization. In other words, operation in the A mode is attained by the crossfader 150 (see FIG. 2) physically mounted, and operation in the V mode is attained by the crossfader 63 (see FIG. 11) or the transition pads 64 (see FIG. 12) which are displayed on GUI on the touch panel TP.

Thus, it is possible to perform a wide range of the mixing processing with the different mixing modes and mixing types, and an operation method thereof can also be changed in accordance with the mixing category even with the mixing operation screen 220, like the effect operation screen 210.

Next, details of the effect operation screen 210 are explained with reference to FIG. 5 to FIG. 10. FIG. 5 is a view showing the effect operation screen 210 when the BPM effect category (performance mode) is selected. As shown in the view, the effect operation screen 210 is provided with the effect category selecting area E1 (category option group) in a screen upper left part, a channel displaying area E2 on the right side of the area E1, the effect type selecting area E3 (effect type option group) below these areas E1 and E2, an effect mode selecting area E4 (mode option group) below the area E3, a video operating area E5 below the area E4, a beat selecting area E6 below the area E5, a BPM auto button 51 on the right side of the effect mode selecting area E4, a video parameter displaying area E7 below the BPM auto button 51 and on the right side of the video operating area E5, and an effect parameter displaying area E8 below the area E7 and on the right side of the video operating area E5.

The effect category selecting area E1 includes icons (BPM, TOUCH, and TEXT) serving as options of the effect category arranged side by side. The icons are displayed in different colors to identify which effect category is selected at present (a selected result by the effect mode selecting unit 340).

In the channel displaying area E2, channel names (CH1, CH2, CH3, CH4, MIC, CF (crossfader) A, CFB, and MASTER) which are selectable as an object to be edited are displayed. Further, the channels are displayed in different colors to identify which channel is selected at present.

In the effect type selecting area E3, icons (DELAY, ECHO, PAN, TRANS, FILTER, FRANGER, PHASER, REVERB, ROBOT, CHORUS, ROLL, and REV ROLL, for example) serving as options of the effect type are arranged side by side. Further, the icons are displayed in different colors to identify which effect type is selected at present.

In the effect mode selecting area E4, icons (the A mode, the AV mode, and the V mode) serving as options of the effect mode are arranged side by side. Further, the icons are displayed in different colors to identify which effect mode is selected at present.

The video operating area E5 is located in the central part of the effect operation screen 210, and a video image based on a video signal of the channel selected as an object to be edited is displayed thereon. In the video operating area E5, reflection or non-reflection of the effect based on the video parameter selected by the video parameter selecting button BT4 for every touch by a user can be switched.

The beat selecting area E6 is provided near the beat button BT6, and includes icons (1/8, 1/4, 1/2, 1/1, 2/1, 4/1, and 8/1, for example) serving as options of a beat type and arranged side by side. The beat type can be selected by the touch of each icon, or the beat button BT6. Further, it is determined whether a beat display or a percent display is used in accordance with the effect type.

The BPM auto button 51 is a button for selecting whether BPM is measured automatically or manually, which can be switched for every touch by the user. The character of “AUTO” or “MANUAL” is displayed on the button so as to identify which one is selected at present.

The video parameter displaying area E7 is provided near the video parameter selecting button BT4, and selectable video parameter names (INVERSE, SEPIA, EDGE, and HUE in the BPM effect category) are displayed thereon. Further, the video parameter names are displayed in different colors to identify which video parameter is selected at present.

The effect parameter displaying area E8 is provided near the effect parameter switching button BT5, and the measured BPM value and the value of the effect parameter selected by the effect parameter switching button BT5 are displayed thereon. Further, the unit of the effect parameter changes depending on the effect type to “ms” or “%”.

Next, the effect operation screen 210 when the BPM effect category (all-in-one mode) is selected will be explained with reference to FIG. 6. Switching from the performance mode shown in FIG. 5 to the all-in-one mode can be made by operation of the effect mode switching button BT1.

The effect operation screen 210 when the all-in-one mode is selected is provided with an output video displaying area E9, in addition to each of the areas E1 to E8 and the BPM auto button 51 as in the case where the performance mode is selected. An arrangement of each area also differs between the case where the all-in-one mode is selected and the case where the performance mode is selected. Only different points from the case where the performance mode is selected will be explained below.

In the effect operation screen 210 when the BPM effect category (all-in-one mode) is selected, with the output video display area E9 being provided in the screen upper part, the options of the effect category selecting area E1 and the effect mode selecting area E4, and the channel names of the channel displaying area E2 are arranged in tandem, and the size (occupation area) of the video operating area E5 is made smaller. Further, the video parameter displaying area E7 and the effect parameter displaying area E8 are arranged above and below the BPM auto button 51, respectively.

The output video displaying area E9 is a monitor which displays output video images. The user can check output video images with the output video displaying area E9 thus provided, without requiring an external monitor or the like.

In this manner, since the output video display area E9 is provided in the effect operation screen 210 in the all-in-one mode, the occupation area of the video operating area E5 is made smaller. Since the size of each icon serving as an option, such as the effect type selecting area E3, is not changed, the compromising effects on operability can be reduced.

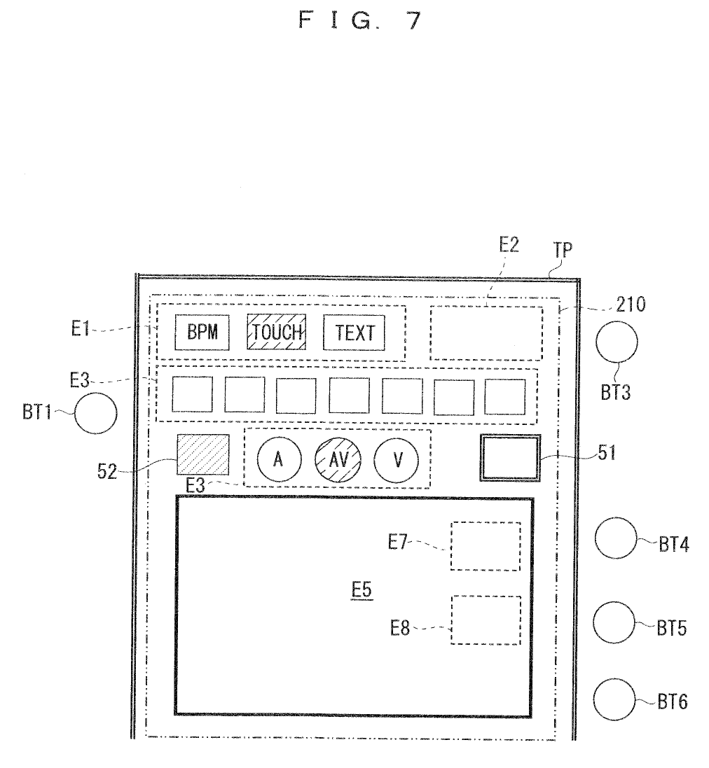

Next, the effect operation screen 210 when the touch effect category (performance mode) is selected will be explained with reference to FIG. 7. Switching from the BPM effect category shown in FIG. 5 to the touch effect category can be made by operation of the effect category selecting area E1.

The effect operation screen 210 when the touch effect category is selected differs from the case where the BPM effect category is selected in that the beat selecting area E6 is not included and a hold button 52 is newly provided, and the parameter selecting button BT4 has different function. Further, it also differs in that the occupation area of the video operating area E5 is made larger, and the video parameter displaying area E7 and the effect parameter displaying area E8 are arranged in the video operating area E5 accordingly. Only different points from the case where the BPM effect category is selected will be explained below.

The hold button 52 is a button for holding (keeping continue) an impact of the effect, and is arranged above the video operating area E5 and on the left side of the effect type selecting area E3.

The parameter selecting button BT4 is a button for selecting a pattern of a way of motion of the video effect. For example, with the effect type “RIPPLE”, the pattern of ripples can be changed into a round shape or a curtain shape.

The video operating area E5 is used as a touch pad, unlike the interface as a switch in the case of the BPM effect category. In other words, position information on the effect can be changed with the XY coordinates on the video operating area E5. A touch on the video operating area E5 serves as a trigger of the effect. Touching on a desired position in the video operating area E5 makes it possible to perform the effect processing, such as applying a ripple effect centering on the position. Further, continuously touching on the video operating area E5 makes it possible to make the effect continue, without operating the hold button 52.

Thus, when the touch effect category is selected, it can be assumed that the video operating area E5 will be frequently accessed as compared with the case where the BPM effect category is selected. Operability can be improved by enlarging the size of the video operating area E5, when the touch effect category is selected.

To clearly show the user that the video operating area E5 can be used as a touch pad, it is preferred to change the specifications of the video operating area E5 (various display modes, such as the color or shape of its outer frame), except for the size, from those with the case where the BPM effect category is selected.

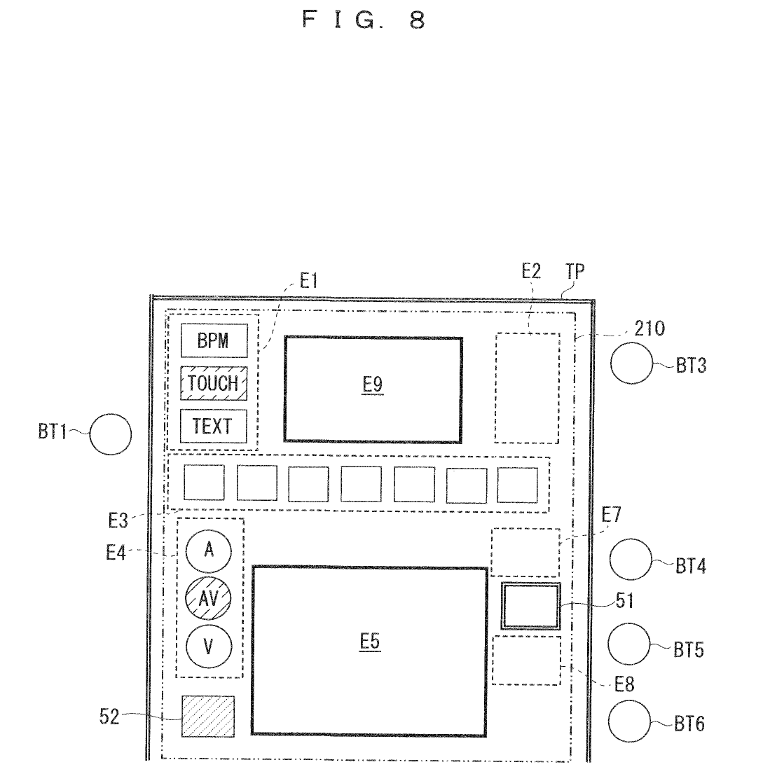

Next, the effect operation screen 210 when the touch effect category (all-in-one mode) is selected will be explained with reference to FIG. 8. The effect operation screen 210 when the all-in-one mode is selected is provided with the output video displaying area E9, in addition to each of the areas (E1 to E8 except E6), the BPM auto button 51, and the hold button 52 as in the case where the performance mode is selected. Further, with the output video display area E9 being provided, the options of the effect category selecting area E1 and the effect mode selecting area E4 and the channel names of the channel displaying area E2 are arranged in tandem, and the occupation area of the video operating area E5 is made smaller. Further, the video parameter displaying area E7 and the effect parameter displaying area E8 are arranged outside the video operating area E5 and above and below the BPM auto button 51, respectively, and the hold button 52 is arranged below the effect mode selecting area E4.

In other words, the effect operation screen 210 when the touch effect category (all-in-one mode) is selected has the specification employing the advantages of both the cases where the BPM effect category (all-in-one mode) shown in FIG. 6 and the touch effect category (performance mode) shown in FIG. 7 are selected.

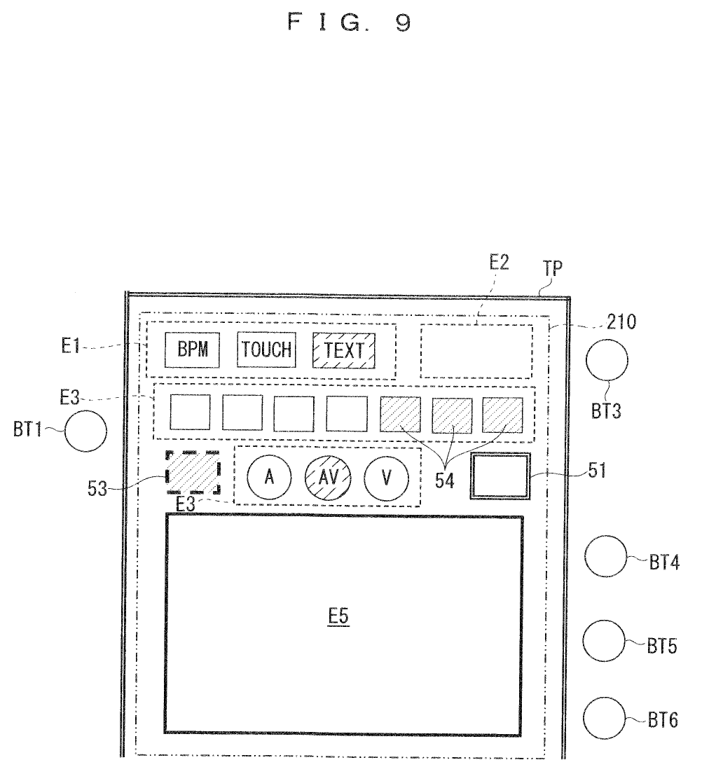

Next, the effect operation screen 210 when the text effect category (performance mode) is selected will be explained with reference to FIG. 9. The effect operation screen 210 when the text effect category is selected differs from the case where the touch effect category is selected (see FIG. 7) in that the hold button 52 is not included, and a text edit button 53 is newly provided. Further, it also differs in that options of a text bank 54 are provided in the effect type selecting area E3, and the video parameter displaying area E7 and the effect parameter displaying area E8, arranged in the video operating area E5, are not included. Only different points from the case where the touch effect category is selected will be explained below.

The text edit button 53 is a button for making the effect operation screen 210 shift to a soft keyboard mode. While a display example of the effect operation screen 210 in the soft keyboard mode is not shown in particular, an area corresponding to the video operating area E5 serves as a soft keyboard and a confirmation screen of keystroke results.

The effect type selecting area E3 is provided with the options of the text bank 54 for calling a text (character string) set in advance, in addition to a part of the above-described effect types (effect types which can be assumed to be frequently used especially in a text input performance). Note that, a text which the user inputs can be registered into the text bank 54.

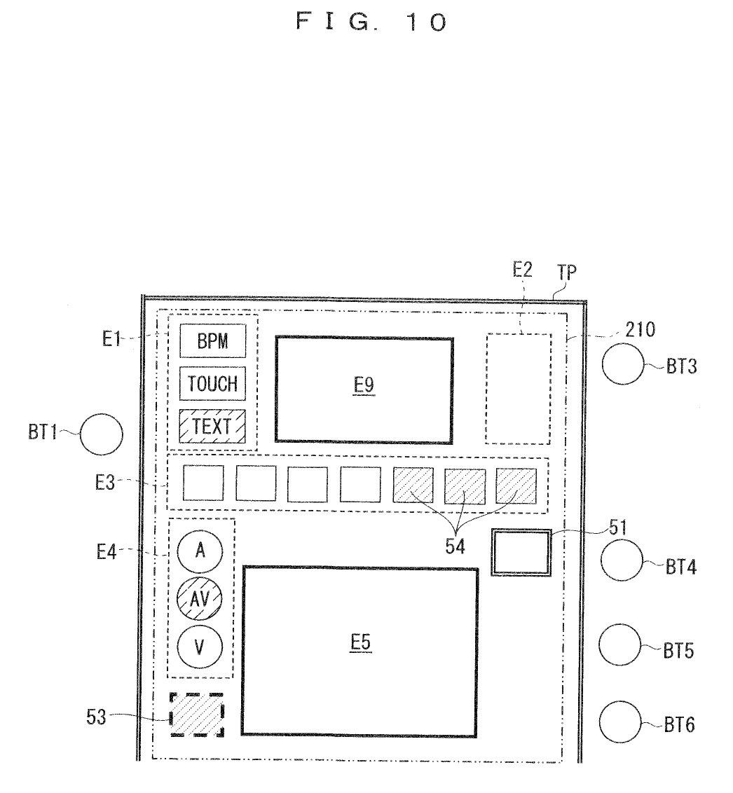

Next, the effect operation screen 210 when the text effect category (all-in-one mode) is selected will be explained with reference to FIG. 10. The effect operation screen 210 when the all-in-one mode is selected is provided with the output video displaying area E9, in addition to each of the areas E1 to E5, the BPM auto button 51, and text edit button 53 as in the case where the performance mode is selected. Further, with the output video display area E9 being provided, the options of the effect category selecting area E1 and the effect mode selecting area E4, and the channel names of the channel displaying area E2 are arranged in tandem, and the occupation area of the video operating area E5 is made smaller. Further, the text edit button 53 is arranged below the effect mode selecting area E4.

In other words, the effect operation screen 210 when the text effect category (all-in-one mode) is selected has the specification employing the advantages of both the cases where the touch effect category (all-in-one mode) shown in FIG. 8 and the text effect category (performance mode) shown in FIG. 9 are selected.

Next, details of the mixing operation screen 220 will be explained with reference to FIG. 11 and FIG. 12. FIG. 11 is a view showing the mixing operation screen 220 when the crossfader category is selected. As shown in the view, the mixing operation screen 220 is provided with the CH monitor area E11 in the screen upper part, the mixing type selecting area E12 below the area E11, the synchronization switching button 62 on the right side of the area E12, the crossfader 63 which is displayed on GUI below the mixing type selecting area E12, and a pair of transformer buttons 61, 61 on the right and left sides of the crossfader 63.

The CH monitor area E11 includes CH monitors 71 which display video images based on the video signals input to CH1 to CH4, and assign bars 72 showing a place where the crossfader 63 is assigned. In the crossfader 63, a track 63b which is a moving range of an operator 63a is displayed in red on the left side and in blue on the right side, for example. The assign bars 72 show the assigned place by being displayed in red or blue (the left or right of the crossfader 63).

The mixing type selecting area E12 includes icons (FADE, WIPE 1/2, CROMA, LUMI, MOTION, for example) serving as options of the mixing type are arranged side by side. The icons are displayed in different colors to identify which effect type is selected at present.

The synchronization switching button 62 is a button for switching “synchronization” for making the position of the crossfader 63 displayed on GUI synchronously move in accordance with the motion of the crossfader 150 arranged physically (see FIG. 2), and “asynchronization” for making the crossfader 150 arranged physically function as a fader for an audio signal, and making the crossfader 63 displayed on GUI function as a fader for a video signal. In other words, video images alone can be changed or mixed by operating the crossfader 63 without changing sound, and conversely, sound alone can be changed or mixed by operating the crossfader 150 without changing video images.

The crossfader 63 includes the operator 63a and the track 63b which is the moving trucking of the operator 63a as described above. When the user moves the operator 63a along the track 63b, an output level of the AV signal assigned to the right and the left can be adjusted. The transformer button 61 is a button for, while being pressed down, minutely generating the sound which is not assigned as main by the crossfader 63.

In this manner, in the crossfader category, using the simple crossfader 63 enables easy operation by DJs' scratching. Further, since the crossfader 63 and the mixing type selecting area E12 are located close to each other, it is preferred to make operation in the mixing type selecting area E12 invalid while the crossfader 63 is being operated.

Next, the mixing operation screen 220 when the transition pad category is selected will be explained with reference to FIG. 12. Switching from the crossfader category shown in FIG. 11 to the transition pad category can be made by operation of the mixing category switching button BT2.

The mixing operation screen 220 when the transition pad category is selected is provided with the transition pads 64, a beat selecting area E13, a memo button 65, and an auto button 66, in addition to the areas E11 and E12, and the synchronization switching button 62 as in the case where the crossfader category is selected. Icons in the mixing type selecting area E12 are arranged in tandem (two rows), not arranged side-by-side, which also differs from the case where the crossfader category is selected. Only different points from the case where the crossfader category is selected will be explained below.

The transition pads 64 prepared in the number of the channels are used for assigning each channel of the AV signal, and can make the channel to be an object of the mixing processing transit in accordance with the assignment by the pad. For example, when “FADE” is selected as an effect type and the pads are touched in order of a pad 1 to a pad 2, a shift to a signal of CH2 from a signal of CH1 is made by a fader method. Note that, the center part of the transition pads 64 is removed in order to prevent touch on the pads of other signals accidentally when two signals to be mix-processed are assigned by the shift of touch positions. Accordingly, operation errors can be significantly reduced.

The beat selecting area E13 has the same function as the beat selecting area (see FIG. 5). The memo button 65 is a button for memorizing the operation result by the transition pads 64. The auto button 66 transits the signals by the order memorized by the memo button 65 or at random, with the beat in harmony with BPM.

In this manner, VJs who handle video images as their specialized field are enabled to operate both sound and video images simply and easily by the transition pad category. Further, the memo button 65 and the auto button 66 can be mounted also in the crossfader category shown in FIG. 11. In this case, the operation by the crossfader 63 can be memorized by pressing down the memo button 65.

As described above, according to the AV processor 30 in this embodiment, since a single apparatus can provide the functions of a plurality of effect categories and mixing categories, space efficiency is so high that initial cost can be reduced substantially, as compared with a case where apparatuses are installed one by one for providing individual functions. Further, the editing processing of both audio signals and video signals can be performed in a single apparatus, thereby further improving space efficiency and reducing initial cost. Further, since each effect category and each mixing category can be operated by using one touch panel TP, downsizing of the apparatus can be attained, as compared with a case where operating units for operating individual categories are provided. Since the specifications of the effect operation screen 210 and the mixing operation screen 220 are changed in accordance with the category which the user selects, operability is not compromised even if a priority is given to downsizing. On the other hand, since the specification of the effect operation screen 210 is not changed in accordance with the effect mode (signal to be an object to be processed), a common operation method can be adopted, which makes it easier for users to learn the operation method. By the common operation method, DJs and VJs can operate music and video images irrespective of their specialties, whereby versatility can be enhanced.

Although the DVJ equipment used in clubs or other venues has been exemplified as the AV processor 30 in the above-described embodiment, the present invention can be applied to devices and programs which can apply effect impacts to AV signals (sound/video effectors, sound/video mixers, sound/video controllers, sound/video processing applications, for example), other than the DVJ equipment. In other words, the present invention can also be applied not only to devices which process both audio signals and video signals, but also to device which processes only audio signals or video signals.

Further, it is possible to provide each part and each function in the AV processor 30 shown in the above-described example as a program. It is also possible to store the program in a recording medium (not shown) to provide it. As a recording medium, CD-ROMs, flash ROMs, memory cards (Compact Flash (registered trademark), smart media, memory sticks, for example) compact discs, magneto-optical discs, digital versatile discs, flexible disks, and hard disks, for example, can be used.

Various changes can be made as required without departing from the sprit and scope of the present invention on the system structure of the AV processing system SY, the equipment configuration and the processing steps of the AV processor 30, for example, not limited to the above-described embodiment.

1. An audio and visual (AV) complex editing apparatus comprising:
an effect category selecting unit which selects any effect category among a plurality of effect categories including a BPM effect category which is a function to perform effect processing mainly in accordance with BPM to an AV signal which is an audio signal or a video signal, and a touch effect category which is a function to perform the effect processing mainly in accordance with an operation result of a video image to the AV signal;
an effect mode selecting unit which selects any effect mode among three effect modes: an audio mode which performs the effect processing only to the audio signal; a video mode which performs the effect processing only to the video signal; and an audio/video mode which performs effect processing to the audio signal and the video;
an operating unit which performs various editing operations including an effect operation for performing the effect processing by using a touch panel with a display function;
a display control unit which performs display control of the touch panel with the display function; and
an effect processing unit which performs the effect processing to at least any one of the audio signal and the video signal, based on selected results by the effect category selecting unit and the effect mode selecting unit, and an operation result by the operating unit,
the display control unit changing a specification of an effect operation screen for performing the effect operation in accordance with the selected result by the effect category selecting unit, and not changing the specification of the effect operation screen in accordance with the selected result by the effect mode selecting unit.

2. The AV complex editing apparatus according to claim 1, wherein the selected result by the effect mode selecting unit is displayed on the effect operation screen.

3. The AV complex editing apparatus according to claim 1, wherein the effect category selecting unit selects any effect category among a plurality of effect categories including a text effect category which is a function to perform the effect processing mainly by using an input result of a text to the AV signal, in addition to the BPM effect category and the touch effect category.

4. The AV complex editing apparatus according to claim 3, wherein an effect type option group for selecting an effect type and a video operating area for displaying the video image and performing a part of the effect operation are displayed on the effect operation screen; and
the display control unit changes, in accordance with the selected result by the effect category selecting unit, at least any one of the effect type included in the effect type option group and a size of the video operating area.

5. The AV complex editing apparatus according to claim 4, further comprising a display area selecting unit which selects whether or not an output video displaying area for displaying an output video image is provided in the effect operation screen,
wherein the display control unit makes the size of the video operating area small, and does not change a size of each option in the effect type option group in a case where the display area selecting unit selects that the output video displaying area is provided, as compared with a case where it is selected that the output video displaying area is not provided.

6. The AV complex editing apparatus according to claim 1, wherein a category option group which displays each option of the effect category selecting unit and a mode option group which displays each option of the effect mode selecting unit are displayed on the effect operation screen.

7. The AV complex editing apparatus according to claim 1,
wherein the operating unit performs a mixing operation for performing mixing processing as the editing operation, and the touch panel with the display function displays a mixing operation screen for performing the mixing operation,
the AV complex editing apparatus further comprising:
a mixing category selecting unit which selects any mixing category among a plurality of mixing categories including a crossfader category which performs the mixing processing to the AV signal by using a crossfader, and a transition pad category which performs the mixing processing to the AV signal by using a transition pad; and
a mixing processing unit which performs the mixing processing to at least any one of the audio signal and the video signal based on operation results by the mixing category selecting unit and the operation result by the operating unit, and
wherein the display control unit changes a specification of the mixing operation screen in accordance with the selected result by the mixing category selecting unit.

8. The AV complex editing apparatus according to claim 7, further comprising a mixing mode selecting unit which selects the video signal only or both the audio signal and the video signal, as an object to be processed by the mixing processing unit, independent from the effect mode selecting unit.

9. An AV processor comprising:
each of the units included in the AV complex editing apparatus according to claim 1;
an input unit to which the AV signal is input; and
an output unit which outputs an output AV signal obtained by effect-processing the input AV signal by the effect processing unit.

10. A program for causing a computer to function as each of the units included in the AV complex editing apparatus according to claim 1.
